(19) United States
(12) Patent Application Publication
(10) Pub. No.: US 2008/0129716 A1
(43) Pub. Date: Jun. 5, 2008

(54) Liquid crystal display device having analog-to-digital circuit

(75) Inventor: Zi-Sheng Li, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/999,088

(22) Filed: Dec. 3, 2007

(30) Foreign Application Priority Data
Dec. 1, 2006 (TW) 95144731

(51) Int. Cl. G06F 3/038; G09G 3/36

(52) U.S. Cl. 345/204; 345/87

(57) ABSTRACT

An exemplary liquid crystal display device (20) includes a liquid crystal display panel (200), a flexible printed circuit (270) and a driving chip (210). The flexible printed circuit includes a conductive line (273). The driving chip includes an interface circuit (230) and an analog-to-digital circuit (260), the analog-to-digital circuit is configured for receiving an analog operating mode signal via the conductive line and transforming the analog operating mode signal to a digital operating mode signal, and providing the digital operating mode signal to the interface circuit. The digital operating mode signal determines an operating mode of the liquid crystal display device.

### FIELD OF THE INVENTION

The present invention relates to liquid crystal display devices, and particularly to a liquid crystal display device having an analog-to-digital circuit.

### GENERAL BACKGROUND

A liquid crystal display (LCD) has the advantages of portability, low power consumption, and low radiation, and has been widely used in various portable information products such as notebooks, personal digital assistants (PDAs), video cameras, and the like. Furthermore, the LCD is considered by many to have the potential to completely replace CRT (cathode ray tube) monitors and televisions.

Referring to FIG. 4, a typical LCD device 10 includes a liquid crystal panel 100, a driving chip 110, and a flexible printed circuit (FPC) 170. The driving chip 110 is arranged on the liquid crystal panel 100, and is electrically connected with the FPC 170. The FPC 170 includes a first conductive line 171, a second conductive line 172, a third conductive line 173, and a fourth conductive line 174. The four conductive lines 171, 172, 173 and 174 are used to transfer operating mode signals.

Referring to FIG. 5, the driving chip 110 includes a timing controller 140, and an interface circuit 130 electrically connected with the timing controller 140. The interface circuit 130 includes a first operating mode signal terminal 131, a second operating mode signal terminal 132, a third operating mode signal terminal 133, and a fourth operating mode signal terminal 134. The operating mode signal terminals 131, 132, 133 and 134 are electrically connected with the conductive lines 171, 172, 173 and 174, respectively. An external circuit (not shown) provides a four-bit operating mode signal to the interface circuit 130 via the FPC 170 and the four conductive lines 171, 172, 173 and 174. The four-bit operating mode signal determines an operating mode of the driving chip 110, and the timing controller 140 works according to the operating mode.

Referring to Table 1, this shows a corresponding relationship between the four-bit operating mode signals and the operating modes. The four-bit operating mode signals include a number of logic states, each of which contributes to determining an operating mode of the driving chip 110. The four-bit operating mode signals are defined by IM0, IM1, IM2 and IM3 respectively. For example, if the external circuit provides a four-bit operating mode signal such as “0100” to the interface circuit 130, the driving chip 110 works in a “16-bit interface and 80-system” operating mode. However, a four-bit operating mode signal “0110” or “**11” corresponds to an invalid setting. The symbol “*” can be a logic state “0” or “1”.

TABLE 1

| IM0 | IM1 | IM2 | IM3 | operating mode |
|---|---|---|---|---|
| 0 | 0 | 0 | 0 | 16-bit interface, 68-system |
| 1 | 0 | 0 | 0 | 8-bit interface, 68-system |
| 0 | 1 | 0 | 0 | 16-bit interface, 80-system |
| 1 | 1 | 0 | 0 | 8-bit interface, 80-system |
| 1 | 0 | 1 | 0 | serial data transfer interface |
| 0 | 1 | 1 | 0 | setting invalid |
| 0 | 0 | 0 | 1 | 18-bit interface, 68-system |
| 1 | 0 | 0 | 1 | 9-bit interface, 68-system |
| 0 | 1 | 0 | 1 | 18-bit interface, 80-system |
| 1 | 1 | 0 | 1 | 9-bit interface, 80-system |
| * | * | 1 | 1 | setting invalid |

According to the above system, the LCD device 10 can work according to a number of different operating modes. Thus the LCD device 10 has good compatibility with a variety of external devices. However, the four-bit signal mode needs four conductive lines 171, 172, 173, 174 in the FPC 170. This makes an area of the FPC 170 rather large, and a layout of the FPC 170 relatively complex. Also, the complex layout is liable to induce crosstalk in the FPC 170.

In an alternative configuration, the LCD device 10 can have only one operating mode stored in the driving chip 110. In such case, most of the conductive lines 171, 172, 173, 174 in the FPC 170 can be omitted. However, this kind of alternative LCD device 10 has very limited compatibility with external devices.

What is needed, therefore, is a liquid crystal display device that can overcome the above-described deficiencies.

### SUMMARY

In one preferred embodiment, a liquid crystal display device includes a liquid crystal display panel, a flexible printed circuit and a driving chip. The flexible printed circuit includes a conductive line. The driving chip includes an interface circuit and an analog-to-digital circuit, the analog-to-digital circuit is configured for receiving an analog operating mode signal via the conductive line and transforming the analog operating mode signal to a digital operating mode signal, and providing the digital operating mode signal to the interface circuit. The digital operating mode signal determines an operating mode of the liquid crystal display device.

Other novel features and advantages of the present liquid crystal display device will become more apparent from the following detailed description when taken in conjunction with the accompanying drawings. In the drawings, all the views are schematic.

### BRIEF DESCRIPTION OF THE DRAWINGS

FIG. 1 is a plan view of a liquid crystal display device according to an exemplary embodiment of the present invention, the liquid crystal display device including a driving chip and an FPC.

FIG. 2 is a block diagram of the FPC and components of the driving chip of FIG. 1, the driving chip components including an analog-to-digital circuit.

FIG. 3 is a block diagram of components of the analog-to-digital circuit of FIG. 2.

FIG. 4 is a plan view of a conventional liquid crystal display device, the liquid crystal display device including a driving chip and an FPC.

FIG. 5 is a block diagram of the FPC and components of the driving chip of FIG. 4.

### DETAILED DESCRIPTION OF PREFERRED EMBODIMENTS

Reference will now be made to the drawing figures to describe various embodiments of the present invention in detail.

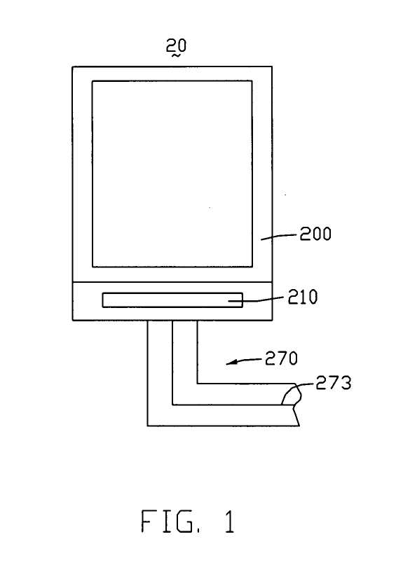

Referring to FIG. 1, a liquid crystal display 20 according to an exemplary embodiment of the present invention is shown. The liquid crystal display 20 includes a liquid crystal panel 200, a driving chip 210, and a flexible printed circuit 270. The driving chip 210 is arranged on the liquid crystal panel 200, and is electrically connected with the FPC 270. The FPC 270 includes a conductive line 273 for transferring analog operating mode signals.

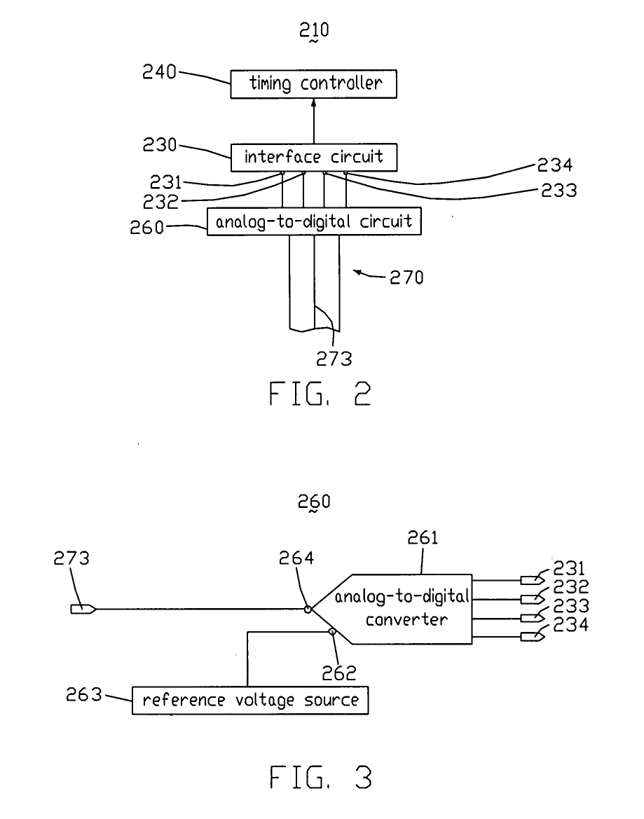

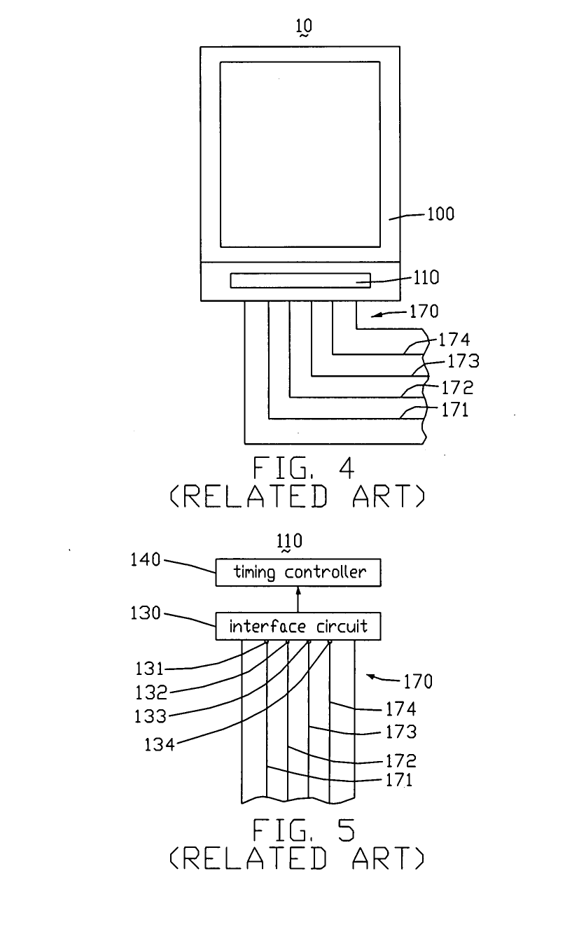

Referring also to FIG. 2, the driving chip 210 includes a timing controller 240, an interface circuit 230, and an analog-to-digital circuit 260. The interface circuit 230 is electrically connected with the timing controller 240 for providing digital operating mode signals to the timing controller 240. The interface circuit 230 includes a first operating mode signal terminal 231, a second operating mode signal terminal 232, a third operating mode signal terminal 233, and a fourth operating mode signal terminal 234. The analog-to-digital circuit 260 is connected with the interface circuit 230 for providing a four-bit operating mode signal to the interface circuit 230 via the four operating mode signal terminals 231, 232, 233, 234 respectively. The conductive line 273 of the FPC 270 is connected with the analog-to-digital circuit 260.

Referring also to FIG. 3, the analog-to-digital circuit 260 includes an analog-to-digital converter 261 and a reference voltage source 263. The analog-to-digital converter 261 includes an analog signal input terminal 264, a reference voltage input terminal 262, and four digital output terminals (not labeled). The reference voltage input terminal 262 is connected to the reference voltage source 263. The analog signal input terminal 264 is connected to the conductive line 273 of the FPC 270. The four digital output terminals are connected with the four operating mode signal terminals 231, 232, 233, 234 of the interface circuit 230 respectively.

The reference voltage input terminal 262 receives a reference voltage from the reference voltage source 263. The reference voltage determines a converting range. The reference voltage is divided into a plurality of sub-range voltages, with each of the sub-range voltages having an amount of voltage width the same as an amount of voltage width of each of the other sub-range voltages. Every sub-range voltage corresponds to a four-bit operating mode signal. The analog signal input terminal 264 receives an analog signal, and then the analog-to-digital converter 261 outputs a corresponding four-bit digital signal.

The driving chip 210 includes a plurality of operating modes. Referring to Table 2, this shows relationships between the sub-range voltages, the four-bit digital signals, and the corresponding operating modes. The maximum valid reference voltage is 950 millivolts (mV), and a range of each sub-range voltage is 100 mV. The analog signal received by the analog-to-digital converter 261 is defined as “IM”, and the four-bit digital signals are defined as “IM0”, “IM1”, “IM2”, and “IM3” respectively. A four-bit operating mode signal “0110” or “**11” corresponds to an invalid setting. The symbol “*” can be a logic state “0” or “1”.

TABLE 2

| IM (mV) | IM0 | IM1 | IM2 | IM3 | operating mode |
|---|---|---|---|---|---|
| <50 | 0 | 0 | 0 | 0 | 16-bit interface, 68-system |
| 50~150 | 1 | 0 | 0 | 0 | 8-bit interface, 68-system |
| 150~250 | 0 | 1 | 0 | 0 | 16-bit interface, 80-system |
| 250~350 | 1 | 1 | 0 | 0 | 8-bit interface, 80-system |
| 350~450 | 1 | 0 | 1 | 0 | serial data transfer interface |
| 450~550 | 0 | 1 | 1 | 0 | setting invalid |
| 550~650 | 0 | 0 | 0 | 1 | 18-bit interface, 68-system |
| 650~750 | 1 | 0 | 0 | 1 | 9-bit interface, 68-system |
| 750~850 | 0 | 1 | 0 | 1 | 18-bit interface, 80-system |
| 850~950 | 1 | 1 | 0 | 1 | 9-bit interface, 80-system |
| >950 | * | * | 1 | 1 | setting invalid |

The operating mode of the interface circuit 230 is determined as follows. An external circuit (not shown) provides an analog signal to the analog-to-digital converter 261 via the conductive line 273 of the FPC 270. For example, the analog signal can be a voltage of 200 mV. The analog-to-digital converter 261 judges that 200 mV is between 150 mV and 250 mV according to Table 2. Thus, the analog-to-digital converter 261 transforms the analog signal to a four-bit digital signal “0100”. The four-bit digital signal “0100” is provided to the four operating mode signal terminals 231, 232, 233, 234 of the interface circuit 230 respectively. Then, the driving chip 210 works in a “16-bit interface, 80-system” operating mode.

Because the driving chip 210 includes the analog-to-digital circuit 260, the FPC 270 only needs one conductive line 273. Compared to a conventional FPC, a layout of the FPC 270 is simplified. In addition, the single conductive line 273 means that minimal (if any) crosstalk is induced in the FPC 270. Furthermore, an area of the FPC 270 can be reduced, so that a cost of the liquid crystal display 20 is correspondingly reduced.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display device comprising:
a liquid crystal display panel;
a flexible printed circuit comprising one conductive line; and
a driving chip comprising an interface circuit and an analog-to-digital circuit, the analog-to-digital circuit being configured for receiving an analog operating mode signal via the conductive line, transforming the analog operating mode signal into a digital operating mode signal, and providing the digital operating mode signal to the interface circuit, wherein the digital operating mode signal determines an operating mode of the driving chip.

2. The liquid crystal display device as claimed in claim 1, wherein the analog operating mode signal is provided to the analog-to-digital circuit from an external circuit via the conductive line of the flexible printed circuit.

3. The liquid crystal display device as claimed in claim 1, wherein the interface circuit comprises four operating mode signal terminals, and the analog-to-digital circuit is connected to the interface circuit via the four operating mode signal terminals.

4. The liquid crystal display device as claimed in claim 3, wherein the analog-to-digital circuit comprises an analog-to-digital converter and a reference voltage source, the reference voltage source providing a reference voltage for the analog-to-digital converter.

5. The liquid crystal display device as claimed in claim 4, wherein the analog-to-digital converter comprises an analog signal input terminal, a reference voltage input terminal, and four digital output terminals.

6. The liquid crystal display device as claimed in claim 4, wherein the analog-to-digital converter transforms the analog operating mode signal to a four-bit digital operating mode signal.

7. The liquid crystal display device as claimed in claim 5, wherein the reference voltage input terminal of the analog-to-digital circuit receives a reference voltage from the reference voltage source.

8. The liquid crystal display device as claimed in claim 7, wherein a maximum valid reference voltage is 950 mV.

9. The liquid crystal display device as claimed in claim 7, wherein the reference voltage is divided into a plurality of sub-range voltages.

10. The liquid crystal display device as claimed in claim 9, wherein a range of each sub-range voltage is 100 mV.

11. A liquid crystal display device comprising:
a liquid crystal display panel;
a flexible printed circuit comprising one conductive line for conveying analog operating mode signals; and
a driving chip comprising an interface circuit and an analog-to-digital circuit, the analog-to-digital circuit being connected with the conductive line for receiving each of the analog operating mode signals, the analog-to-digital circuit being connected with the interface circuit, the analog-to-digital circuit transforming each analog operating mode signal to a digital operating mode signal, and providing the digital operating mode signal to the interface circuit, the digital operating mode signal determining an operating mode of the driving chip.

12. The liquid crystal display device as claimed in claim 11, wherein the analog operating mode signal is provided to the analog-to-digital circuit from an external circuit via the conductive line of the flexible printed circuit.

13. The liquid crystal display device as claimed in claim 11, wherein the interface circuit comprises four operating mode signal terminals, the analog-to-digital circuit comprises an analog-to-digital converter and a reference voltage source, the analog-to-digital converter comprises an analog signal input terminal, a reference voltage input terminal, and four digital output terminals, the reference voltage source provides a reference voltage for the analog-to-digital converter via the reference voltage input terminal, and the four digital output terminals are connected to the four operating mode signal terminals of the interface circuit.

14. The liquid crystal display device as claimed in claim 13, wherein the analog-to-digital converter transforms the analog operating mode signal to a four-bit digital operating mode signal.

15. The liquid crystal display device as claimed in claim 13, wherein a maximum valid reference voltage is 950 mV.

16. The liquid crystal display device as claimed in claim 13, wherein the reference voltage is divided into a plurality of sub-range voltages.

17. The liquid crystal display device as claimed in claim 16, wherein a range of each sub-range voltage is 100 mV.
